(19) United States
(12) Patent Application Publication
(10) Pub. No.: US 2009/0178284 A1
(43) Pub. Date: Jul. 16, 2009

(54) Telescoping eating utensil

(76) Inventor: Marvin Lane, Round Lake Beach, IL (US)

Correspondence Address: WOOD, PHILLIPS, KATZ, CLARK & MORTIMER, 500 W. MADISON STREET, SUITE 3800, CHICAGO, IL, 60661, US

(21) Appl. No.: 12/008,572

(22) Filed: Jan. 11, 2008

(51) Int. Cl. B25G 1/04

(52) U.S. Cl. 30/340

(57) ABSTRACT

An eating utensil (10) includes a telescoping handle (12) and a head (14) in the form of an eating implement such as a spoon head (16). The handle (12) includes first, second, and third members (18, 20, 22) that are joined for telescopic motion relative to each other along a longitudinal axis (24 between an extended state and a retracted state, with the member (22) carrying the head (14) between the extended state and the retracted state.

### CROSS-REFERENCE TO RELATED APPLICATIONS

Not Applicable.

### FEDERALLY SPONSORED RESEARCH OR DEVELOPMENT

Not Applicable.

### MICROFICHE/COPYRIGHT REFERENCE

Not Applicable.

### FIELD OF THE INVENTION

This invention relates to eating utensils such as spoon, forks, knifes, and sporks.

### BACKGROUND OF THE INVENTION

It is known to provide eating utensils that can be moved between a useable or extended state where the utensil can be used for eating or serving food and a storage or shortened state wherein the utensil is folded to shorten its overall length for storage. While many of the known constructions may work well for their intended purpose, there is always room for improvement.

### SUMMARY OF THE INVENTION

In accordance with one feature of the invention, an eating utensil includes a head in the form of an eating implement, and a telescoping handle. The telescoping handle includes at least two members that are joined for telescopic motion relative to each other along a longitudinal axis between an extended state and a retracted state, with one of the members carrying the head between the extended state and the retracted state. The handle has a first end spaced from a second end along the longitudinal axis in the retracted state, and the head does not extend past the first or second end in the retracted state.

As one feature, one of the members includes a pair of channels extending parallel to the longitudinal axis and slidably receiving the elongate surfaces on another of the members. In a further feature, the channels face each other and the surfaces face away from each other.

In accordance with one feature of the invention, an eating utensil includes a head in the form of an eating implement, and a telescoping handle. The handle includes first, second, and third members that are joined for telescopic motion relative to each other along a longitudinal axis between an extended state and a retracted state, with one of the members carrying the head between the extended state and the retracted state.

In one feature, the first member extends along the longitudinal axis between first and second ends, and the second member does not extend past either of the ends in the retracted state. As a further feature, the third member carries the head, and third member and the head do not extend past either end in the retracted state.

According to one feature, the first member includes a pair of channels extending parallel to the longitudinal axis, and the second member includes a pair of elongate surfaces extending parallel to the longitudinal axis and slidably received in the channels. In a further feature, the channels face each other and the surfaces face away from each other. As another feature, the second member further includes a another pair of channels extending parallel to the longitudinal axis, and the third member includes a pair of elongate surfaces extending parallel to the longitudinal axis and slidably received in the another pair of elongate channels.

As one feature, the first member has a first length, the second member has a second length that is nested completely within the length of the first member in the retracted state, and the third member and head have a combined length that is less than the first length.

In one feature, the head is in the form of one of a spoon head, fork head, knife blade, or spork head.

According to one feature, the handle members are releasably engaged to each other to allow the members to be completely separated and reassembled for cleaning.

In one feature, the handle members include injection molded material.

As one feature, the head includes stamped metal.

Other objects, features, and advantages of the invention will become apparent from a review of the entire specification, including the appended claims and drawings.

### BRIEF DESCRIPTION OF THE DRAWINGS

FIG. 1 is a perspective view from above showing a telescoping eating utensil in an extended state;

FIG. 2 is a perspective view similar to FIG. 1, but showing the eating utensil in a retracted state;

FIG. 3 is a perspective view from below showing the eating utensil in the extended state;

FIG. 4 is a view similar to FIG. 3 but showing the eating utensil in a retracted state;

FIG. 5 is a left side view of the eating utensil;

FIG. 6 is a view from below of the eating utensil;

FIG. 7 is a front view of the eating utensil;

FIG. 8 is an exploded perspective view of the eating utensil, with two of the members shown partially broken;

FIG. 9 is a perspective view from above showing a fork head for use with the eating utensil;

FIG. 10 is a perspective view from above showing a spork head for use with the eating utensil; and

FIG. 11 is a perspective view from above showing a knife blade for use with the eating utensil.

### DETAILED DESCRIPTION OF THE PREFERRED EMBODIMENT

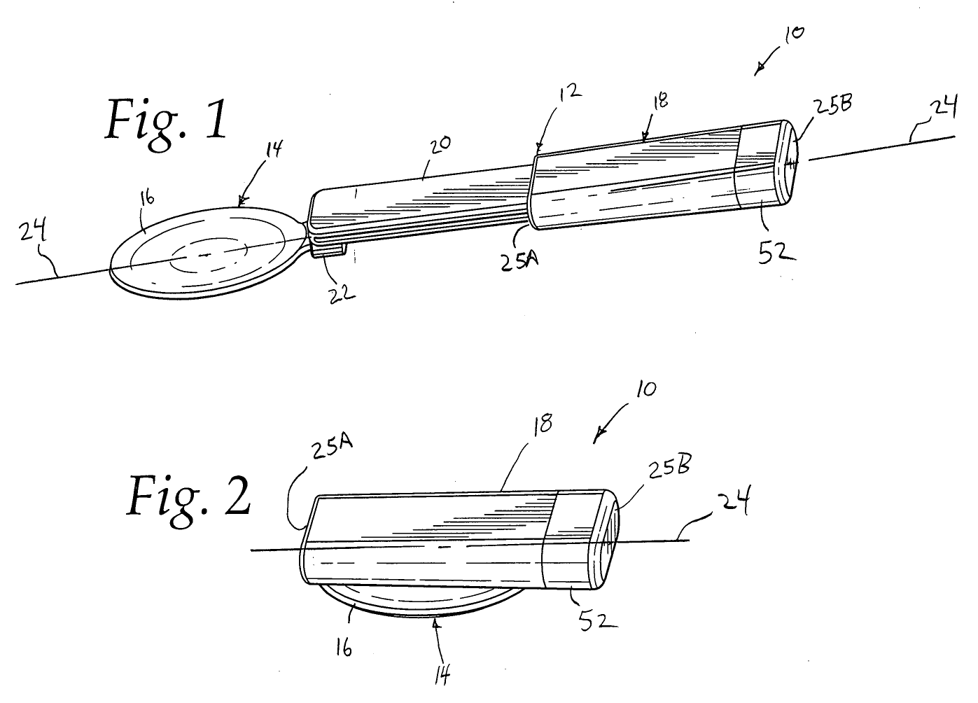

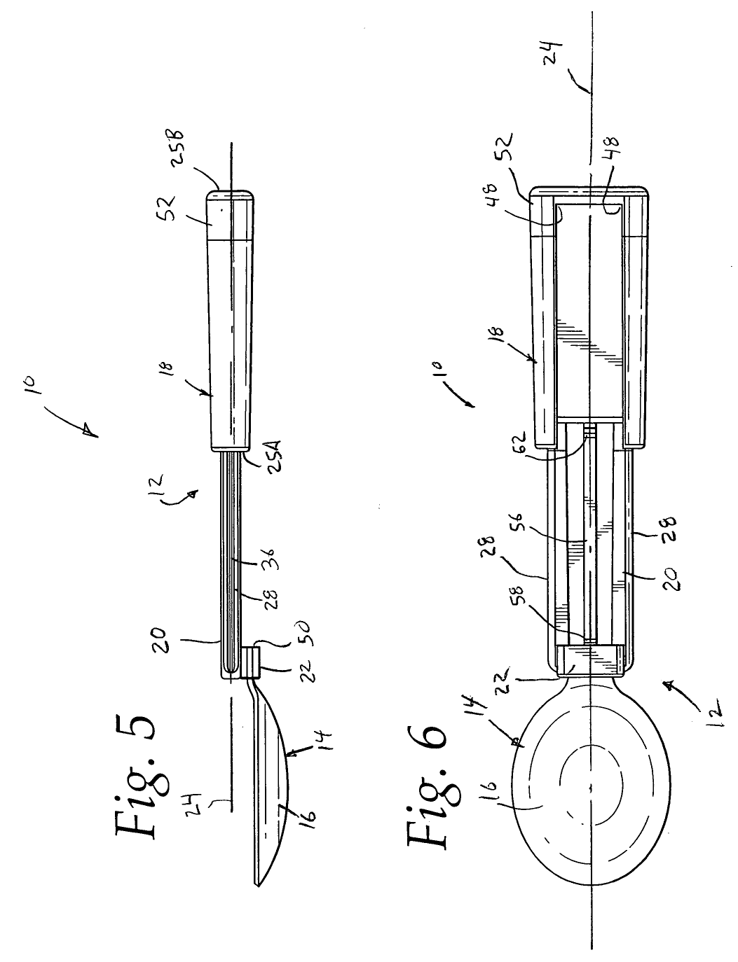

As best seen in FIG. 1, an eating utensil 10 includes a telescoping handle 12 and a head 14 in the form of an eating implement such as a spoon head 16. The handle 12 includes first, second, and third members 18, 20, and 22 that are joined for telescopic motion relative to each other along a longitudinal axis 24 between an extended state shown in FIGS. 1, 3 and 5-7 and a retracted state shown in FIGS. 2 and 4, with the member 22 carrying the head 14 between the extended state and the retracted state.

As best seen in FIG. 2, the second member 20 preferably has a longitudinal length that is nested completely within the longitudinal length of the first member 18 in the retracted state so that the second member 20 does not extend past the longitudinally spaced ends 25A and 25B of the first member 18. It is also preferred that the third member 22 and the head 14 have a combined longitudinal length that is less than the length of the first member 18 so that in the retracted state the third member 22 and the head 14 do not extend past the ends 25A and 25B and the longitudinal length of the first member 18 defines the max longitudinal dimension for the utensil 10.

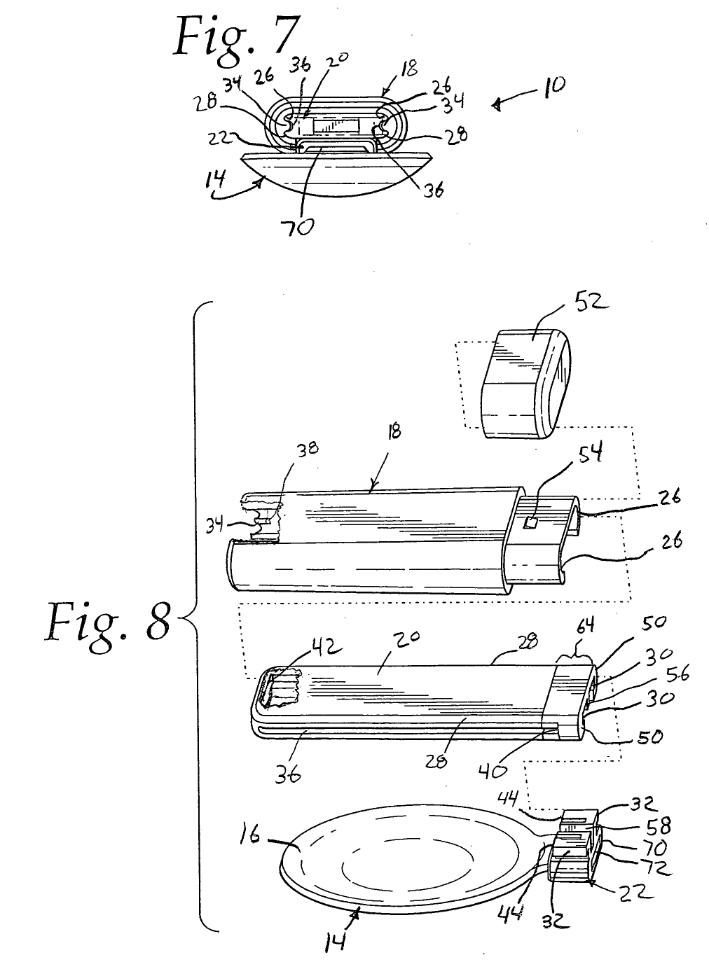

As best seen in FIGS. 7 and 8, the first member 18 includes a pair of inwardly facing channels 26 extending parallel to the longitudinal axis 24, and the second member 20 includes a pair of outwardly facing elongate surfaces 28 extending parallel to the longitudinal axis 24, with each of the channels 26 slidably receiving a corresponding one the surfaces 28. The second member 20 further includes a pair of inwardly facing channels 30 extending parallel to the longitudinal axis 24, and the third member 22 includes a pair of outwardly facing elongate surfaces 32 extending parallel to the longitudinal axis 24, with each of the channels 30 slidably receiving a corresponding one of the surfaces 32.

While the illustrated embodiment shows the channels 26 facing each other, the channels 30 facing each other, the surfaces 28 facing away from each other, and the surfaces 32 facing away from each other, it should be appreciated that in some applications it may be desirable for the channels 26 to face away from each other with the corresponding surfaces 28 facing each other, and/or for the channels 30 to face away from each other with the corresponding surfaces 32 facing each other. Similarly, while the channels 26 and 30 are shown on the members 18 and 20 respectively, and the surfaces 28 and 32 are shown on the members 20 and 22 respectively, in some applications it may be desirable for the channels 26 to be provided on the member 18 and the corresponding surfaces 28 to be provided on the member 20, and/or for the channels 30 to be provided on the member 22 and the corresponding surfaces 32 to be provided on the member 20.

As best seen in FIGS. 7 and 8, each of the channels 26 includes an inwardly facing, elongate rib 34 and each of the surfaces 28 includes an outwardly facing, elongate groove 36 that receives a corresponding one of the ribs 34. Each rib 34 terminates at a rearward facing end surface 38 (only one shown in FIG. 8) and each groove terminates at a forward facing end surface 40 that abut each other in the extended state to limit the extension of the member 20 from the member 18. Similarly, each of the channels 30 terminates at a rearward facing surface 42 and each of the surfaces 32 terminates at a forward facing end surface 44 that abut each other in the extended state to limit the extension of the third member 22 from the second member 20.

Each of the channels 26 also terminates at a forward facing surface 48, best seen in FIG. 6) and each of the surfaces 28 terminates at a rearward facing surface 50 that abut each other in the retracted state to limit retraction of the member 20 into the member 18. Preferably in this regard, the surface 48 is provided on a cap piece 52 of the member 18 that Is snap fit at 54 to the remainder of the member 18 to allow assembly of the member 20 into the member 18 by opening the channels 26, as best seen in FIG. 8. Removal of the cap piece 52 allows the member 20 to be slid out of engagement with the member 18 and the member 22 to be slid out of engagement with the member 22 for cleaning of the members 18-22 or replacement of selected members 18-22.

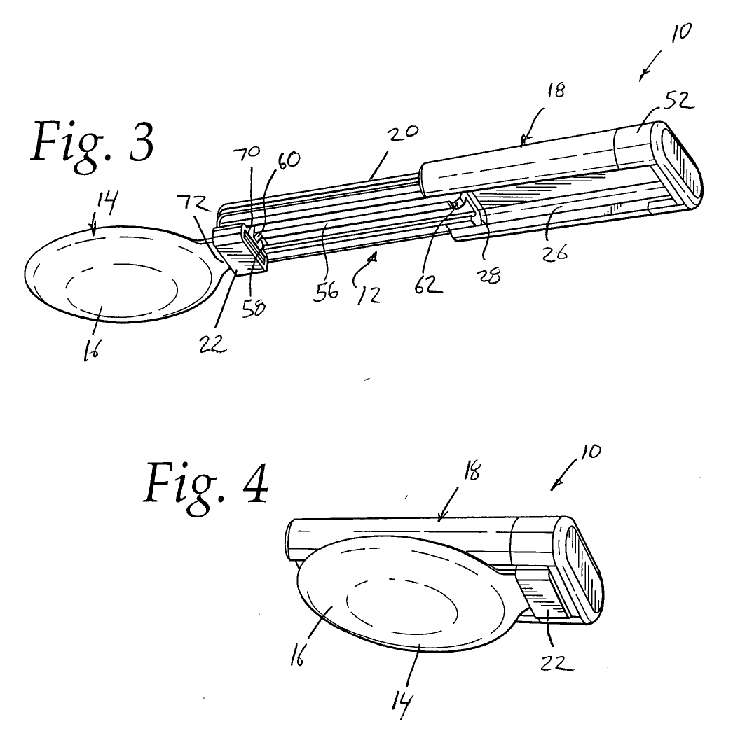

As best seen in FIGS. 3 and 8, the member 20 includes a central, elongate rib 56 extending parallel to the axis 24 and the member 22 includes a central, elongate groove 58 that receives the rib 56. Preferably, the rib 56 includes a pair of protrusions 60 and 62 at opposite ends of the rib 56 for frictional engagement with the groove 58 to retain the member 22 in the extended state when engaged with the protrusion 60 and in the retracted state when engaged with the protrusion 62. As best seen in FIG. 8, the surfaces 28 can be made slightly larger over an end portion 64 of the member 22 to provide a frictional engagement with the member 18 to retain the member 22 in either the extended or retracted position.

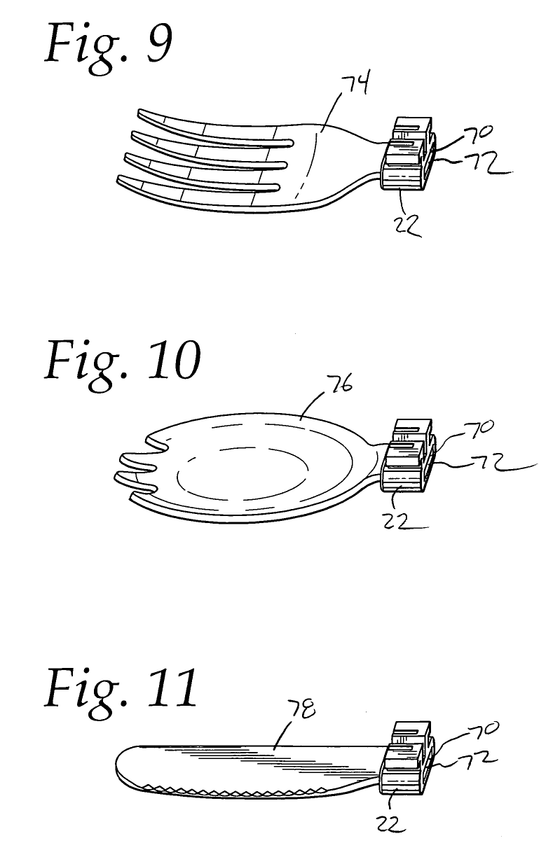

The member 22 includes an opening 70 that receives a tongue 72 of the head 14. Preferably the tongue 72 is fixed in the opening 70 by a suitable interference fit and/or a suitable bonding agent. As seen in FIGS. 9-11, in addition to the spoon head 16, the member 22 can carry any suitable head 14 for eating or food preparation, including, for example, a fork head 74 as shown in FIG. 9, a spork head 76 as shown in FIG. 10, and a knife head 78 as shown in FIG. 11. If it is desired for the heads 16, and 74-78 to be interchangeable as a set, each of the heads 16, 74, 76, and 78 can be removable attached to the member 22 using a suitable attachment, such as a frictional or snap connection.

While any material suitable for eating and cooking utensils may be used, it is preferred that the members 18, 20, and 22 be injection molded from a suitable plastic or other suitable material, and the heads 16, 74, 76, and 78 be made from a suitable metal, preferably by stamping. However, in some applications it may be desirable for the members 18-22 and the heads 16 and 74-78 to all be made from the same material, such as all made from a suitable plastic or all made from a suitable metal, and it may further be desired for the head 14 to be made as an integrated structure with the member 22 so that the member 22 and head 14 are a one piece construction rather than a joined two piece construction.

1. An eating utensil comprising:
a head in the form of an eating implement;
a telescoping handle comprising at least two members that are joined for telescopic motion relative to each other along a longitudinal axis between an extended state and a retracted state, one of the members carrying the head between the extended state and the retracted state, the handle has a first end spaced from a second end along the longitudinal axis in the retracted state, and the head does not extend past the first or second end in the retracted state.

2. The eating utensil of claim 1 wherein the head is in the form of one of a spoon head, fork head, knife blade, or spork head.

3. The eating utensil of claim 1 wherein one of the members comprises a pair of channels extending parallel to the longitudinal axis and slidably receiving elongate surfaces on another of the members.

4. The eating utensil of claim 3 wherein the channels face each other and the surfaces face away from each other.

5. The eating utensil of claim 1 wherein the handle members are releasably engaged to each other to allow the members to be completely separated and reassembled for cleaning.

6. The eating utensil of claim 1 wherein the handle members comprise injection molded material.

7. The eating utensil of claim 6 wherein the head comprises stamped metal.

8. An eating utensil comprising:
a head in the form of an eating implement;
a telescoping handle, the handle comprising first, second, and third members that are joined for telescopic motion relative to each other along a longitudinal axis between an extended state and a retracted state, one of the members carrying the head between the extended state and the retracted state.

9. The eating utensil of claim 8 wherein the head is in the form of one of a spoon head, fork head, knife blade, or spork head.

10. The eating utensil of claim 8 wherein the first member extends along the longitudinal axis between first and second ends, and the second member does not extend past either of the ends in the retracted state.

11. The eating utensil of claim 10 wherein the third member carries the head, and third member and the head do not extend past either end in the retracted state.

12. The eating utensil of claim 8 wherein the first member comprises a pair of channels extending parallel to the longitudinal axis, and the second member comprises a pair of elongate surfaces extending parallel to the longitudinal axis and slidably received in the channels.

13. The eating utensil of claim 12 wherein the channels face each other and the surfaces face away from each other.

14. The eating utensil of claim 12 wherein the second member further comprises a another pair of channels extending parallel to the longitudinal axis, and the third member comprises a pair of elongate surfaces extending parallel to the longitudinal axis and slidably received in another pair of channels.

15. The eating utensil of claim 8 wherein the first member has a first length, the second member has a second length that is nested completely within the length of the first member in the retracted state, and the third member and head have a combined length that is less than the first length.

16. The eating utensil of claim 8 wherein the handle members are releasably engaged to each other to allow the members to be completely separated than reassembled for cleaning.

17. The eating utensil of claim 18 wherein the handle members comprise injection molded material.

18. The eating utensil of claim 17 wherein the head comprises stamped metal.
